(19) United States
(12) Patent Application Publication
(10) Pub. No.: US 2017/0373306 A1
(43) Pub. Date: Dec. 28, 2017

(54) CARBON-METAL/ALLOY COMPOSITE MATERIAL, SYNTHESIS METHOD, AND ELECTRODE INCLUDING SAME

(71) Applicant: Sharp Kabushiki Kaisha, Osaka (JP)

(72) Inventors: Paul ADAMSON, Oxford (GB); Emma KENDRICK, North Warnborough (GB)

(21) Appl. No.: 15/189,366

(22) Filed: Jun. 22, 2016

(51) Int. Cl. H01M 4/36; C04B 35/64; H01M 2/16; H01M 4/131; H01M 4/133; H01M 4/136; H01M 4/38; C04B 35/52; H01M 10/054; H01M 10/0525; H01M 4/66; H01M 4/62; H01M 4/583; H01M 4/58; H01M 4/505; H01M 4/485; H01M 10/0566

(52) U.S. Cl. CPC H01M 4/364; H01M 10/0566; C04B 35/64; H01M 2/1613; H01M 2/162; H01M 2/1653; H01M 4/131; H01M 4/133; H01M 4/136; H01M 4/38; C04B 35/52; H01M 10/054; H01M 10/0525; H01M 4/661; H01M 4/625; H01M 4/624; H01M 4/623; H01M 4/583; H01M 4/58; H01M 4/505; H01M 4/485; H01M 4/387; C04B 2235/422; C04B 2235/661; C04B 2235/781; C04B 2235/785; H01M 2300/0025; C04B 2235/40; C04B 2235/405; C04B 2235/407; C04B 2235/786

(57) ABSTRACT

A carbon-metal/alloy composite material includes a composition represented by (1-a)Sn₁₋ₓM¹ₓ+aM²+cC, wherein: M¹ includes one or more transition metals, metals, or metalloids; M² includes one or more transition metals, metals, or metalloids; x is 0≦x≦1; a is 0≦a≦1; and c is 0<c≦99. A method of forming the carbon-metal/alloy composite material includes the steps of dissolving one or more precursor materials in a solvent to form a solution; adding an organic carbon forming precursor to the solution to form a mixture; heating the mixture in an autoclave reactor for a prescribed period of time; separating solids formed from the mixture after the heating; washing the separated solids with a washing solvent; and heating the washed solids under a non-oxidizing atmosphere to form the carbon-metal/alloy composite material.

### TECHNICAL FIELD

This disclosure relates to a carbon-metal/alloy composite material, and a method of preparing the carbon-metal/alloy composite material. The present disclosure also relates to an electrode including the carbon-metal/alloy composite material for a metal ion battery that stores electrical energy and provide electrical energy.

### BACKGROUND ART

Metal-ion cells are a family of rechargeable cell types which are capable of storing and providing energy. In its most basic form, a metal-ion cell comprises an anode (negative electrode), a cathode (positive electrode) and an electrolyte material. This may be considered as a “cell unit”. A “cell stack” consists of multiple cell units stacked vertically and/or horizontally. Multiple cell units or multiple cell stacks may be used in conjunction to form a battery.

The most widespread example of a metal-ion battery is the lithium ion battery. Lithium-ion batteries are widely used in consumer electronic devices and are also growing in popularity in other applications such as electric vehicles. Metal-ion batteries all have the same basic structure and charge and discharge via a similar reaction mechanism. For example, when a lithium-ion battery is charging, Li+ions deintercalate from the cathode and insert into the anode. Meanwhile charge balancing electrons pass from the cathode through the external circuit containing the charger and into the anode of the battery. During discharge, the same process occurs but in the opposite direction with the external circuit able to power a load. Sodium-ion batteries are analogous in many ways to the lithium-ion batteries that are in common use today, but instead a sodium ion Na⁺ shuttles between the cathode and anode in place of the lithium ions Li⁺. Lithium is not a cheap metal to source and is often considered too expensive for use in large scale applications. By contrast, sodium-ion battery technology is still in its relative infancy but is seen as potentially advantageous; sodium is much more abundant than lithium and some researchers predict this will provide a cheaper and more durable way to store energy into the future, particularly for large scale applications such as storing energy on the electrical grid.

The parts of the electrode which the metal ions either intercalate into, or alloy with, hold onto the surface of, and/or hold within the pores of are referred to as an active material in the battery. In contrast, other components may be present, for example, as a substrate to support the active material, as a conductive additive, to bind the electrode components together, and/or to promote adhesion or flexibility.

There is a general drive to increase the energy density of the active materials in metal-ion batteries. A greater storage capacity in the active material may allow, for example, a smaller battery size in a device and/or extra energy available to the device being powered or for a greater battery life between charges. In addition to battery capacity, the cycle life of a battery is also an important factor, with many applications demanding hundreds or in some cases thousands of cycles with only a small fraction of the initial capacity becoming unusable. Approaches which can increase the energy density of metal-ion batteries are to develop high voltage cathode active materials or to develop high capacity anode and cathode active materials.

The energy density of an electrochemical cell can be specified either in Wh/Kg for the gravimetric energy density or in Wh/I for the volumetric energy density. The performance of the active materials contained in the anode or cathode can be characterized by a specific charge or discharge capacity, usually referred to just as “specific capacity,” which again may be either a specific gravimetric capacity or a specific volumetric capacity (mAh/g, mAh/cm³). An ideal anode active material has a high specific capacity and a low electrochemical potential. The lower electrochemical potential allows for a higher voltage available to the external circuit when the anode is placed against a cathode material within a battery cell, and the higher specific capacity allows for the intercalation or alloying of more of the metal ions.

The most popular anode for room temperature lithium-ion batteries is graphite. The positive features of graphite are a flat and low working potential versus lithium, however the intercalation of lithium into graphite is limited to only one lithium ion for every six carbon atoms, 6C+Li⁺+e⁻→LiC6 with a resulting reversible capacity of 372 mAhg⁻¹. For sodium-ion batteries the larger sodium ions cause exfoliation of the graphite anode, and therefore other forms of carbon such as hard carbon (also known as amorphous carbon) or expanded graphite oxide are often used. These hard carbon or expanded graphite oxide materials have a specific capacity of approximately 250-300 mAhg⁻¹ with an average voltage of approximately 0.2V vs Na. To achieve high cycling efficiency and long cycle life, the movement of sodium ions into and out of the cathode and anode active materials should not change or damage the crystal structure.

Other potential electrode material such as metal oxides or metal alloys, which intercalate or alloy with sodium, have large theoretical capacities and may provide an increased specific capacity and hence an increased energy density of the cell. But one practical problem with these materials is the large volume changes which accompany the alloying of the metal ions (e.g., Na⁺) with the metal or metal alloy anode. This causes pulverisation of the metal or metal alloy particles and rapid capacity fade of the battery cells.

Efforts have been made to reduce the extent of this pulverization. For example, the use of nanostructured electrodes may provide room for this expansion and reduce the extent of pulverisation, thereby increasing the cycle life, and have been studied for lithium ion and sodium ion batteries. The use of nanocomposites as anode materials in metal-ion batteries has also been studied, for example tin-graphite or silicon-graphite composites. Also described in the literature is the use of a carbon matrix with higher capacity anode active material particles, wherein the presence of a conductive carbon matrix can absorb the large volume changes during cycling, with an improved cycle life reported for increasing carbon content. In some examples, a composite has been used in an electrochemical cell to try to mitigate the issues concerning the pulverization of the metal or metal alloy material during cycling.

International Application Publication No. WO2014141732A1 (Zhu et al., published Sep. 18, 2014) describes a tin-metal complex and a method of producing the same. The complex comprises a carbon sheet-like matrix and tin nanoparticles in the sheet-like matrix. The Sn nanoparticles range in diameter from 0.2 to 5 nm and particles with a diameter greater than 1 um are not contained. The invention provides a synthesis method that uses a cationic polymer and sulphuric acid. The use of the invention as a negative electrode in a non-aqueous lithium ion battery is described.

Chinese Patent Application No. CN104577075A (Li et al., published Apr. 29, 2015) discloses a graphitized mesoporous carbon/tin composite negative electrode material for lithium ion batteries. The nanotin is embedded in the pore walls of the mesoporous carbon. This invention describes a synthesis route involving a solid-liquid grinding template method. Vegetable oil is the carbon precursor; hydrated tin chloride is the tin source and mesoporous silicon oxide is a template. The silicon oxide is chemically removed after a heat treatment step.

U.S. Pat. No. US8,945,431B2 (Schultz et al., published Feb. 3, 2015) describes a process for producing electrically conductive, porous, silicon- and/or tin-containing carbon materials. The use of these materials as anodes in lithium ion batteries is also described. In the synthesis method provide silicon and/or tin nanoparticles are dispersed in at least one organic polymer and the polymer is carbonized in a heat treatment step.

United States Patent Application Publication No. US2014/0170491A1 (Chen et al., published Jun. 19, 2014) provides a composition that includes mesoporous carbon domains, incorporated with particles of metal or metal oxide. The metal is at least one of tin, cobalt, copper, molybdenum, nickel, iron, or ruthenium (or oxide). The use of a composition in a battery electrode which has a specific capacity of more than 1000 mAh/g after 15 cycles is described.

International Application Publication No. WO2014081786A1 (Obrovac et al., published May 30, 2014) describes an anode for sodium ion batteries. The anode includes an electrochemically active phase and an electrochemically inactive phase that share at least one common phase boundary. The electrochemically active phase is essentially free of crystalline grains greater than 40 nm.

U.S. Pat. No. US8,765,862B2 (Matsumura et al., published Jul. 1, 2014) describes a composite which comprises a matrix resin layer in which metal nanoparticles are immobilized. A method of producing the metal nanoparticles is provided. The metal nanoparticles are in the range 1-100 nm. The metal nanoparticles are formed by metals from gold (Au), silver (Ag), copper (Cu), palladium (Pd), platinum (Pt), tin (Sn), rhodium (Rh), and iridium (Ir).

Bresser et al., “Embedding tin nanoparticles in micron-sized disordered carbon for lithium- and sodium-ion anodes” (Electrochimica Acta 128 (2014) 163-171) describe a method of making a tin-carbon nanocomposite. This synthesis involves mixing together Sn acetate and sugar before heating at high temperature.

### SUMMARY OF INVENTION

In accordance with one aspect of the present disclosure, a carbon-metal/alloy composite material comprising a composition represented by Chemical Formula (1):

(1-a)Sn₁₋ₓM¹ₓ+aM²+cC (1)

wherein: M¹ includes one or more transition metals, metals, or metalloids; M² includes one or more transition metals, metals, or metalloids; x is 0≦x≦1; a is 0≦a≦1; and c is 0<c≦99, wherein the carbonaceous component is a non-macroporous material and the metal/alloy component (1-a)Sn₁₋ₓM¹x+aM² is embodied as particles dispersed in the non-macroporous carbonaceous component (C).

In some embodiments, M¹ is chromium, titanium, vanadium, iron, manganese, cobalt, nickel, copper, zinc, gallium, indium, silicon, germanium, or antimony.

In some embodiments, M² is chromium, titanium, vanadium, iron, manganese, cobalt, nickel, copper, zinc, gallium, indium, silicon, germanium, or antimony.

In some embodiments, M¹ is the same material as M². In some embodiments, M¹ is a different material than M².

In some embodiments, a is 0. In some embodiments, a is 1.

In some embodiments, one or both of M¹ and M² includes more than one material.

In some embodiments, the metal/alloy component particles are spherical particles.

In some embodiments, the average size of the metal/alloy component particles is 5 nm to 500 nm.

In some embodiments, the non-macroporous carbonaceous component (C) is embodied as matrix particles having an average size of 1 μm-150 μm.

In accordance with another aspect of the present disclosure, an electrode including the carbon-metal/alloy composite material.

In accordance with another aspect of the present disclosure, a metal-ion cell includes: an anode including the carbon-metal/alloy composite material; a cathode; and a separator comprising an ionically conducting electrolyte medium.

In accordance with another aspect of the present disclosure, a method of forming a carbon-metal/alloy composite material including a composition represented by Chemical Formula (1):

(1-a)Sn₁₋ₓM¹ₓ+aM²+cC (1)

wherein: M¹ includes one or more transition metals, metals, or metalloids; M² includes one or more transition metals, metals, or metalloids; x is 0≦x≦1; a is 0≦a≦1; and c is 0<c≦99, the method including: dissolving one or more precursor materials in a solvent to form a solution; adding an organic carbon precursor to the solution to form a mixture; heating the mixture in an autoclave reactor for a prescribed period of time; separating solids formed from the mixture after the heating; washing the separated solids with one or more washing solvents; and heating the washed solids under a non-oxidizing atmosphere to form the carbon-metal/alloy composite material.

In some embodiments, the organic carbon precursor includes ethylene glycol.

In some embodiments, the method further includes adding an acid or alkali to form the mixture. In some embodiments, the acid includes an organic acid. In some embodiments the organic acid is citric acid

In some embodiments, the washing solvent includes ethylene glycol.

In some embodiments, the washing solvent includes water.

In some embodiments, the method further includes grinding the carbon-metal/alloy composite material into a powder.

In some embodiments, the carbonaceous component is a non-macroporous material and the metal/alloy component (1-a)Sn₁₋ₓM¹ₓ+aM² is embodied as particles dispersed in the non-macroporous carbonaceous component (C).

In some embodiments, the non-macroporous carbonaceous component (C) is embodied as solid matrix particles. In some embodiments, the average size of the matrix particles is 1 μm-150 μm.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a flow chart showing an exemplary synthesis method for producing the carbon-metal/alloy composite material of the present disclosure.

FIG. 2 shows X-ray powder diffraction patterns from Example 1 of a carbon-metal/alloy composite material of the present disclosure collected before and after the heat treatment under an inert atmosphere.

FIG. 3 is a scanning electron microscopy (SEM) image from Example 1 of Sn-carbon composite after heating to 800° C. under flowing nitrogen. 100 μm scale bar shown. Carbon particles <100 μm are seen.

FIG. 4 is another SEM image from Example 1of Sn-carbon composite after heating to 800° C. under flowing nitrogen. 1.00 μm scale bar shown.

FIG. 5 is a graph showing charge capacity data collected for an electrode formulated using Sn nanoparticles and an electrode formulated with the composite provided by the present disclosure.

FIG. 6 is an X-ray powder diffraction pattern collected after heat treatment under an inert atmosphere of a precursor mixture containing both Sn and Cu.

FIG. 7 is a schematic illustration of a metal-ion electrochemical cell containing the carbon-metal/alloy composite material of the present disclosure.

### DETAILED DESCRIPTION OF INVENTION

Hereinafter, the embodiments of the present disclosure will be described with reference to the accompanying tables and figures.

In the following description an active material describes a component of either a cathode or an anode which contributes to the capacity of the electrode. The cathode is the positive electrode of the cell and the anode is the negative electrode of the cell. An active component refers to a component of an electrode which is electrochemically active and therefore either inserts, hosts, alloys with or mixes with the metal ions which are moving between the cathode and anode.

### Carbon-Metal/Alloy Composite Material

The carbon-metal/alloy composite material of the present disclosure may be represented by Chemical Formula (1):

(1-a)Sn₁₋ₓM¹ₓ+aM²+cC (1)

wherein:

M¹ includes one or more transition metals, metals, or metalloids,

M² includes one or more transition metals, metals, or metalloids;

x is in the range 0≦x≦1

a is in the range 0≦a≦1; and

c is in the range 0<c≦99.

Hence, Chemical Formula (1) represents a composite material including a metal/alloy component (1-a)Sn₁₋ₓM¹ₓ+aM², and a carbonaceous component cC. The metal/alloy particles may be dispersed throughout the carbonaceous support matrix.

The letters a and x represent the stoichiometry of the material constituents. In some embodiments, the value of a and x may be an integer (i.e., a whole number). In other embodiments, the value of one or more of a and x may be a non-integer (i.e., a fraction).

In some embodiments, a is O. Accordingly, in some embodiments, (1-a)Sn₁₋ₓM¹ₓ may be the only metal/alloy component in the composite material. In other embodiments, a is 1. Accordingly, in some embodiments, aM² may be the only metal/alloy component in the composite material. In other embodiments, a may be a value other than 0 or 1 such that both (1-a)Sn_{1-x—xM}¹ₓ and aM² may be present in the composite material. In some examples the value of a is in the range of 0≦a<1. In other examples the value of a, is in the range of 0≦a≦0.25. In other examples, the value of a is in the range of 0.25≦a≦0.5. In other examples, the value of a is in the range of 0.5≦a≦0.75. In other examples, the value of a is in the range of 0.75≦a≦1.

In some examples the value of x, representing the amount of M¹ in (1-a)Sn₁₋ₓM¹ₓ is in the range of 0≦x≦0.25. In other examples, the value of x is in the range of 0.25≦a≦0.5. In other examples, the value of x is in the range of 0.5≦a≦0.75. In other examples, the value of x is in the range of 0.75≦a≦1.

In some examples the value of c, representing the amount of C is in the range of 0<c≦25. In other examples, the value of c is in the range of 25≦c≦50. In other examples, the value of c is in the range of 50≦c≦75. In other examples, the value of c is in the range of 75≦c≦99.

In some embodiments, M¹ may be the same material as M². Accordingly, in some embodiments, M¹ and M² in Chemical Formula (1) may both be generally represented as M. In other embodiments, M¹ may be a different material than M².

In some embodiments, M¹ includes one or more transition metals, metals, or metalloids. Exemplary transition metals include titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold. Exemplary metals and metalloids include magnesium, zinc, calcium, beryllium, strontium, barium, aluminium, gallium, indium, silicon, germanium, antimony and boron. In some embodiments, M¹ is selected from chromium, titanium, vanadium, iron, manganese, cobalt, nickel, copper, zinc, gallium, indium, silicon, germanium or antimony. In some embodiments, M¹ includes a single material. In other embodiments, M¹ includes more than one component. For example, M¹ may be a binary material or a ternary material.

In some embodiments, M² includes one or more transition metals, metals, or metalloids. Exemplary transition metals include titanium, vanadium, chromium, manganese, iron, cobalt, nickel, copper, yttrium, zirconium, niobium, molybdenum, rhodium, palladium, silver, cadmium, hafnium, tantalum, tungsten, osmium, platinum, and gold. Exemplary metals and metalloids include magnesium, zinc, calcium, beryllium, strontium, barium, aluminium, gallium, indium, silicon, germanium, antimony and boron. In some embodiments, M² is selected from chromium, titanium, vanadium, iron, manganese, cobalt, nickel, copper, zinc, gallium, indium, silicon, germanium or antimony. In some embodiments, M² includes a single material. In other embodiments, M² includes more than one component. For example, M² may be a binary material or a ternary material.

The carbon-metal/alloy composite material may have one or more distinct properties. For example, the carbon-metal/alloy composite material may contain a metal and/or alloy capable of alloying with alkali metals. The metal/alloy may form discrete particles having an average size which are under 500 μm in diameter. The spherical particles may be contained in a carbonaceous matrix and may be dispersed throughout the carbonaceous matrix.

The carbonaceous support matrix may be a solid, non-macroporous material. Accordingly, the metal/alloy component (1-a)Sn₁₋ₓMₓ+aM may be embodied as particles dispersed in a solid, non-macroporous carbonaceous component (C). The following porosity types may be grouped as follows:

Microporous: pore diameters of less than 2 nm

Mesoporous: pore diameters 2 nm to 49 nm

Macroporous: pore diameters equal to or greater than 50 nm

The carbonaceous support matrix (whether in particulate form or in another form) may be a non-macroporous material. It will be appreciated that in some embodiments the carbonaceous support matrix may include mesopores and/or micropores, but the carbonaceous support matrix may be a non-macroporous material in that the pores (if any) of the support matrix are smaller than macroporous pores.

In some embodiments, the carbonaceous support matrix may be embodied as one or more matrix particles. The term “matrix particle” as used herein refers to a carbonaceous component of the composite which hosts the metal/alloy component and may or may not also be active. The term “particle” as used herein is not intended to limit the scope of the present disclosure and, unless specified to the contrary, may include a solid of any size or shape. In some embodiments, the average size of the matrix particles may be about 1 μm to about 150 μm. In some embodiments, the carbonaceous component may be provided in one or more other forms (e.g., a sheet, film, or other suitable shape).

The metal/alloy may form discrete particles which may have an average size of about 500 nm or less in diameter. The particles may be spherical particles which have an average size of about 500 nm or less in diameter. In other embodiments, the particle may have another suitable non-spherical shape. The average size of the particles may also be greater than 5 nm in size/diameter.

In some embodiments, the carbon-metal/alloy material may be utilized as part of an electrode. The electrode may contain one or more of the composite materials described above, suitable for use in energy storage applications such as rechargeable batteries.

In some embodiments, the carbon-metal/alloy material may be utilized as part of an energy storage device that utilises electrodes according to the present disclosure as described above. As an example, the energy storage device may be one or more of the following: a sodium and/or lithium and/or potassium ion cell; a sodium and/or lithium and/or potassium metal cell; a non-aqueous electrolyte sodium and/or potassium ion; an aqueous electrolyte sodium and/or lithium and/or potassium ion cell.

In some embodiments, a battery may include one or more of the metal/alloy composite materials of the present application, and particularly a sodium or lithium ion battery or other electrical storage device including grid connected electrical energy storage systems or devices.

In some embodiments, the carbon-metal/alloy material may be utilized as a catalyst for use in organic chemistry reactions. Exemplary catalytic reactions include, but are not limited to, hydrogenation reactions, cracking of petroleum derived compounds, Fischer-Tropsch synthesis, hydrodesulphurisation, and hydroformylation. The sodium transition metal silicate materials of the present disclosure may be embodied as the active material in such catalytic reactions.

### Synthesis Method

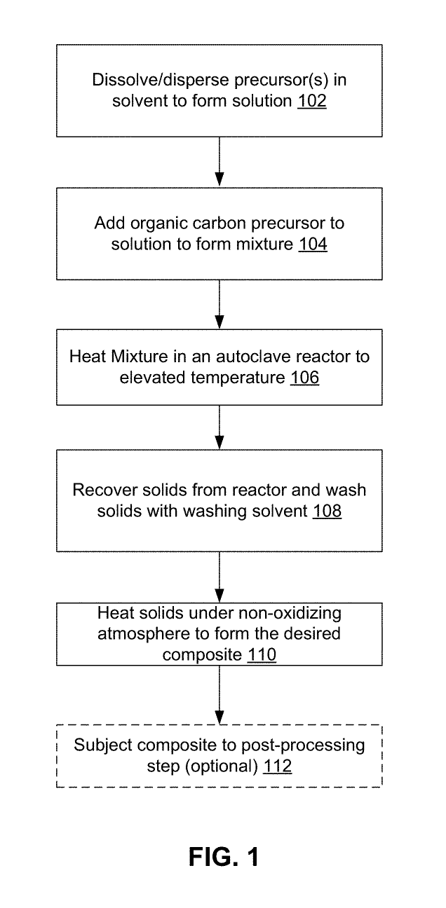

FIG. 1 is a flow chart showing an exemplary synthesis method for producing a carbon-metal/alloy composite material in accordance with the present disclosure. The produced composite material includes a carbonaceous support matrix and metal/alloy particles dispersed through the support matrix. The composite materials may be synthesised by a hydrothermal technique:

At step 102, one or more soluble precursor materials are dissolved/dispersed in a solvent to form a solution. The soluble precursor materials(s) chosen for use depend largely on the types of metal/alloy component to be yielded. In some embodiments, the one or more soluble precursor materials include, for example, metal chlorides. Exemplary metal chlorides include SnCl₂, CoCl₂, NiCl₂, CuCl₂, and the like. Other exemplary precursors include metal salts such as metal acetylacetates, nitrates, sulfates, acetates, iodides, bromides, phosphates, carbonates, borates, fluorides, selenates. In some embodiments, the solvent may be water. In other embodiments, alternative or additional solvents to water such as ethanol, ethylene glycol, methanol, isopropyl alcohol, ether, acetonitrile or hexanol, N-methyl Pyrilodine (NMP), trimethyl benzene (TMB), Xylene may be used wholly or in part as the solvent. The solution may be stirred for 2 minutes to 12 hours. In other embodiments, the solution may be stirred for 30 minutes to 2 hours. In some embodiments, the mixing may be conducted at room temperature (e.g., at about 25° C.). In other embodiments, the mixing may be conducted at an elevated temperature (e.g., about 26° C. to about 180° C.). The elevated temperature may be lower than that of the boiling point of the solvent or may be under reflux conditions if higher than the boiling point of the solvent.

At step 104, an organic carbon forming precursor is added to the solution to form a mixture. In some embodiments, the organic carbon forming precursor includes one or more organic solvents. Exemplary organic carbon forming precursors include ethylene glycol, diethylene ether, diglyme, triglyme, tetraglyme, polyethylene glycol, diethylene carbonate (DEC), ethylene carbonate (EC), dodecanol, hexanol, isopropyl alcohol. The mixture may be mixed for any suitable amount of time in order to homogeneously mix the mixture.

In some embodiments, at step 104, one or more acids or alkalis may be added to the mixture. Exemplary acids include L-ascorbic acid, ascorbic acid, oxalic acid, formic acid, Ethylenediaminetetraacetic (EDTA) and citric acid. Exemplary alkalis include, lithium hydroxide, sodium hydroxide, ammonium hydroxide or potassium hydroxide. The one or more acids or alkalis may assist in the control of the particle size and/or shape of the carbonaceous component (C).

At step 106, the mixture is sealed in an autoclave reactor and heated to an elevated temperature for a prescribed period of time. Heating in the autoclave reactor may result in the hydrolysis of metal salt and decomposition of the carbon source. In some embodiments, the heating may be conducted at a temperature ranging from about 80° C. to about 300° C. In other embodiments, the heating may be conducted at a temperature ranging from about 200° C. to about 250° C. In some embodiments, the heating may be conducted for a time period ranging from 2 minutes to 12 hours. In other embodiments, the heating may be conducted for a time period ranging from 30 minutes to 2 hours.

At step 108, solids are recovered from the reactor and washed with one or more appropriate washing solvents. In some embodiments, the washing solvent is ethylene glycol and ethanol. The solids are then dried. In an example, the solids may be dried in a vacuum oven. The heating may be conducted at a suitable temperature and for a suitable time to effect evaporation.

At step 110, the solids may be heated under a non-oxidizing atmosphere (e.g., in a nitrogen atmosphere, air purged, or reducing atmosphere) to form the desired composite. The atmosphere may be CO/CO2, CO2, H2/N2, H2, SO2, or Argon. In some embodiments, the precursor is heated to temperatures between 200° C. and 1300° C. fora period of time ranging from 5 minutes to 24 hours. In some embodiments, the precursor is heated to temperatures between 500° C. and 1300° C. for a period of time ranging from 5 minutes to 24 hours. The heat treatment step may reduce the components of the solids to produce metal nanoparticles dispersed on a carbonaceous matrix. The metal nanoparticles may be greater than 5 nm in size/diameter. The metal nanoparticles may also be less 500 nm in diameter.

Subsequently, at step 112 (optional), the composite material may be subjected to one or more post-processing steps. In one example, the composite material can be ground into a fine powder. As an example, the metal/alloy particles may be 10 nm-250 nm in diameter and are dispersed throughout the matrix particles which are 2μm-100 μm in size.

The carbon-metal/alloy composite material produced by the above method may have one or more benefits. Firstly, the metal/alloy particles and matrix particles are formed at the same time, resulting in an intimate mixture. Secondly, the metal/alloy particles are contained in the matrix particles which can buffer volume changes associated with (de)alloying with alkali metals. Thirdly, the matrix material is carbonaceous and may or may not be active depending on the reaction conditions. Fourthly, the small particle size allows alloying without pulverisation resulting in enhanced cycle life. Fifthly, the addition of an organic acid to the reaction mixture may allow for control of the particle size and shape.

Using the above synthesis method, several materials were prepared. These exemplary materials are summarised in Table 1. The samples produced and set forth in Table 1 demonstrate that the formed composite material may include, for example, metal, binary alloys, and ternary alloys.

TABLE 1
Summary of exemplary carbon-metal/alloy composite materials
produced using the exemplary synthesis method of FIG. 1

| | | | | Hydro- |
|---|---|---|---|---|
| | | | | thermal |
| | | | | conditions |
| | | STARTING | | Furnace |
| Sample | TARGET | MATERIALS | Solvents | conditions |
| 1 | Sn/C | SnCl2 | Ethylene | 220° C. |
| | | (0.008 mol) | glycol | 800° C. |
| | | L-ascorbic acid | Water | N₂ |
| | | (0.016 mol) | (30 mL, | |
| | | | 4:1 vol.) | |
| 2 | Cu12Sn10/C | CuCl2 | Ethylene | 220° C. |
| | | (0.006 mol) | glycol | 800° C. |
| | | SnCl2 | Water | N₂ |
| | | (0.005 mol) | (30 mL, | |
| | | L-ascorbic acid | 4:1 vol.) | |
| | | (0.022 mol) | | |
| 3 | Ga68In22Sn10/ | SnCl2 | Ethylene | 220° C. |
| | C | (0.0008 mol) | glycol | 1200° C. |
| | | Ga acetylacetate | Water | N₂ |
| | | (0.00176 mol) | (30 mL, | |
| | | In acetate | 4:1 vol.) | |
| | | (0.00544 mol) | | |
| | | Ascorbic acid | | |
| | | (0.016 mol) | | |
| 4 | Sn/C | SnCl2 | Ethylene | 220° C. |
| | | (0.008 mol) | glycol | 800° C. |
| | | Oxalic acid | Water | N₂ |
| | | (0.016 mol) | (30 mL, | |
| | | | 4:1 vol.) | |
| 5 | Sn/C | SnCl2 | Ethylene | 220° C. |
| | | (0.008 mol) | glycol | 800° C. |
| | | Formic acid | Water | N₂ |
| | | (0.016 mol) | (30 mL, | |
| | | | 4:1 vol.) | |
| 6 | Sn/C | SnCl2 | Ethylene | 220° C. |
| | | (0.008 mol) | glycol | 800° C. |
| | | Oxalic acid | Water | N₂ |
| | | (0.016 mol) | (30 mL, | |
| | | | 1:4 vol.) | |
| 7 | Sn/C | SnCl2 | Ethylene | 220° C. |
| | | (0.008 mol) | glycol | 800° C. |
| | | L-ascorbic acid | Water | N₂ |
| | | (0.016 mol) | (30 mL, | |
| | | | 1:4 vol.) | |
| 8 | Sn/C | SnCl2 | Ethylene | 220° C. |
| | | (0.008 mol) | glycol | 800° C. |
| | | Formic acid | Water | N₂ |
| | | (0.016 mol) | (30 mL, | |
| | | | 1:4 vol.) | |
| 9 | Sn/C | SnCl2 | Ethylene | 220° C. |
| | | (0.008 mol) | glycol | 800° C. |
| | | Oxalic acid | Water | N₂ |
| | | (0.016 mol) | (30 mL, | |
| | | | 2:3 vol.) | |
| 10 | Sn/C | SnCl2 | Ethylene | 220° C. |
| | | (0.008 mol) | glycol | 800° C. |
| | | L-ascorbic acid | Water | N₂ |
| | | (0.016 mol) | (30 mL, | |
| | | | 2:3 vol.) | |
| 11 | Sn/C | SnCl2 | Ethylene | 220° C. |
| | | (0.008 mol) | glycol | 800° C. |
| | | Formic acid | Water | N₂ |
| | | (0.016 mol) | (30 mL, | |
| | | | 2:3 vol.) | |
| 12 | Sn/C | SnCl2 | Ethylene | 220° C. |
| | | (0.008 mol) | glycol | 800° C. |
| | | Citric acid | Water | N₂ |
| | | (0.016 mol) | (30 mL, | |
| | | | 4:1 vol.) | |
| 13 | Sn/C | SnCl2 | Ethylene | 220° C. |
| | | (0.008 mol) | glycol | 800° C. |
| | | Citric acid | Water | N₂ |
| | | (0.016 mol) | (30 mL, | |
| | | | 1:4 vol.) | |
| 14 | Sn/C | SnCl2 | Ethylene | 220° C. |
| | | (0.008 mol) | glycol | 1200° C. |
| | | L-ascorbic acid | Water | N₂ |
| | | (0.016 mol) | (30 mL, | |
| | | | 4:1 vol.) | |
| 15 | Sn/C | SnCl2 | Ethylene | 220° C. |
| | | (0.008 mol) | glycol | 1100° C. |
| | | L-ascorbic acid | Water | N₂ |
| | | (0.016 mol) | (30 mL, | |
| | | | 4:1 vol.) | |
| 16 | Sn/C | SnCl2 | Ethylene | 220° C. |
| | | (0.008 mol) | glycol | 1000° C.° |
| | | L-ascorbic acid | Water | N₂ |
| | | (0.016 mol) | (30 mL, | |
| | | | 4:1 vol.) | |
| 17 | Sn/C | SnCl2 | Ethylene | 220° C. |
| | | (0.008 mol) | glycol | 900° C. |
| | | L-ascorbic acid | Water | N₂ |
| | | (0.016 mol) | (30 mL, | |
| | | | 4:1 vol.) | |
| 18 | CoSn/C | CoCl2 | Ethylene | 220° C. |
| | | (0.006 mol) | glycol | 800° C. |
| | | SnCl2 | Water | N₂ |
| | | (0.006 mol) | (30 mL, | |
| | | L-ascorbic acid | 4:1 vol.) | |
| | | (0.024 mol) | | |
| 19 | Ni3Sn4/c | NiCl2 | Ethylene | 220° C. |
| | | (0.0045 mol) | glycol | 800° C. |
| | | SnCl2 | Water | N₂ |
| | | (0.0060 mol) | (30 mL, | |
| | | L-ascorbic acid | 4:1 vol.) | |
| | | (0.021 mol) | | |

Exemplary Procedure to Make and cycle a Sodium Metal Electrochemical Test Cell:

Electrochemical cells were prepared for use in connection with conventional electrochemical testing techniques.

Materials were tested as cast electrodes. To prepare an electrode of the test material the sample was prepared using a solvent-casting technique, from a slurry containing the active material (e.g., the carbon-metal/alloy composite material), conductive carbon, binder and solvent. The conductive carbon used in the slurry was a carbon black C45 (Timcal). PVdF was used as the binder, and NMP (N-Methyl-2-pyrrolidone, Anhydrous, Sigma, UK) is used as the solvent. The slurry was then cast onto a carbon-coated aluminium current collector using the Doctor-blade technique. The electrode was then dried under Vacuum at about 80-120° C. for 2 hours to 12 hours. As formed, the electrode film contained the following components, expressed in percent by weight: 80% active material, 10% carbon black, and 10% PVDF binder. Optionally, this ratio can be varied to optimise the electrode properties such as, adhesion, resistivity and porosity.

The electrolyte includes a 1.0 M solution of NaPF6 in A 1:1 mixture of ethylene carbonate and diethylene carbonate with 5 wt % fluoroethylene carbonate as an additive, and can also be any suitable or known electrolyte or mixture thereof. A glass fibre separator (e.g. Whatman, GF/A) or a porous polypropylene separator (e.g. Celgard 2400) wetted by the electrolyte is interposed between the positive and negative electrodes forming the electrochemical test cell. Electrochemical cells of materials prepared according to the procedures outlined in Table 1 were tested using Constant Current Constant Voltage Cycling Techniques. Typically, cells were discharged galvanostatically at a rate of 30 mA/g followed by a constant voltage step which was maintained until current decayed to one tenth of its initial value. The cells were charge galvanostatically at a rate of 30 mA/g. The cells were cycled between pre-set voltage limits as deemed appropriate for the material under test, typically between 0.01 and 0.8 V. A commercial battery cycler from Maccor Inc. (Tulsa, Okla., USA) was used.

### Structural Characterization:

All of the product materials were analysed by X-ray diffraction techniques using a Bruker D2 phaser powder diffractometer (fitted with a Lynxeye™ detector) to confirm that the desired target materials had been prepared, and also to establish the phase purity of the products and to determine the types of impurities present. From this information it is possible to determine the unit cell lattice parameters.

The operating conditions used to obtain the powder diffraction patterns illustrated, are as follows:
Range: 2θ=10°-90°
X-ray Wavelength =1.5418 Å (Cu Kα)
Step size: 2θ=0.02
Speed: 1.5 seconds/step

### EXAMPLE 1

Example 1 is an example relating to sample 1 provided above in Table 1, and is an example of a Sn-carbon composite prepared using the above-described synthesis method.

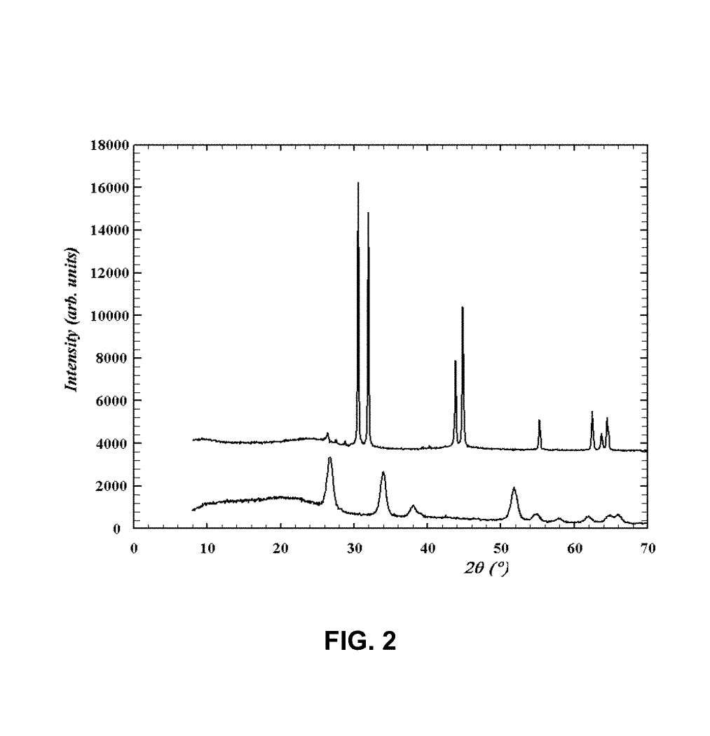

FIG. 2 shows X-ray powder diffraction patterns collected at different stages of the synthesis procedure. Tin is the only metallic component in the target composition for this synthesis. The X-ray diffraction pattern at the bottom of the figure is from the material produced after the hydrothermal step. This pattern contains broad reflections due to the presence of small particles of a crystalline material. Peaks at 2theta positions of approximately 27, 34, 38, 52, 55, 58, 62, 65 and 66° 2theta identify these reflections as being due to diffraction from SnO2 crystallites. The upper pattern was collected after the same material had been heat treated under an inert atmosphere at 800 C for two hours. The sharp peaks at 2theta angles of approximately 30, 32, 44, 45, 55, 62, 64 and 65° 2theta confirm the formation of metallic Sn. Only one of the peaks detailed above remains but its intensity has been greatly reduced and is evidence of the high purity of the Sn metal produced by the method in the present invention. The absence of any significant peaks at the locations identified above for SnO2 provide evidence of the high purity of samples prepared using this method.

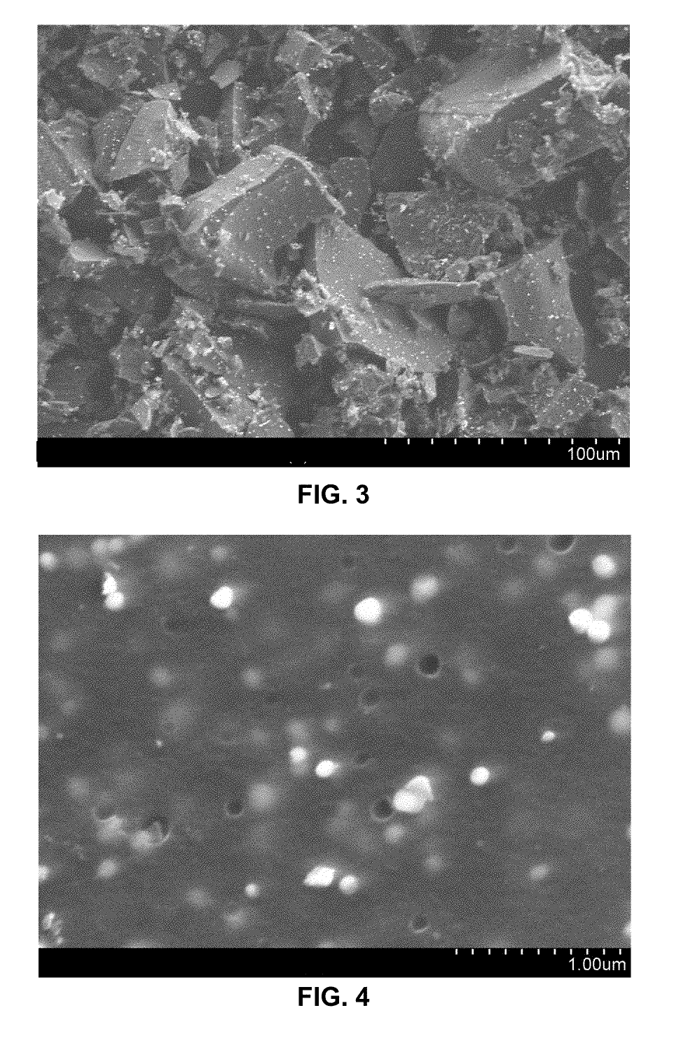

The SEM images shown in FIGS. 3 and 4 were obtained after the heat treatment under an inert atmosphere. FIG. 3 is a SEM image of Sn-carbon composite after heating to 800° C. under flowing nitrogen. FIG. 3 demonstrates the general morphology of these materials. Large irregular shaped particles of carbon are evident and are typically <100 μm across. FIG. 4 is another SEM image of Sn-carbon composite after heating to 800° C. under flowing nitrogen. FIG. 4 shows one of these particles at a higher level of magnification. The surface of the carbon particle is decorated with particles of Sn, evident as light coloured areas in the micrograph. These particles are typically 100 nm or less in diameter. The Sn particles are also contained inside the carbon particle as evidenced by the light grey areas in the micrograph.

The addition of the L-ascorbic acid may promote the formation of spherical Sn particles as described above. The benefit of the above-described synthesis method is the encapsulation of these particles in a carbon matrix which is capable of buffering volume changes.

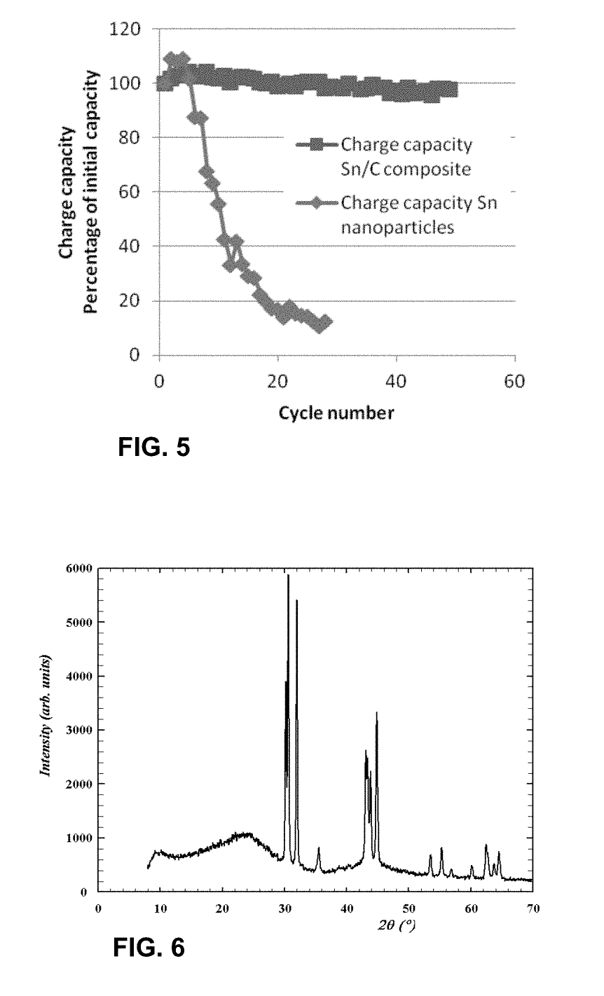

As described above, in some embodiments of the present disclosure, as the carbon-metal/alloy composite material is included in an electrode for use in a sodium-ion battery. The material produced in accordance with Example 1 was processed along with a carbon-based additive and binding agent into an electrode which was then cycled electrochemically against metallic sodium. FIG. 5 is a graph showing charge capacity data collected for an electrode formulated using Sn nanoparticles and an electrode formulated with the composite provided by the present disclosure. The data shown in FIG. 5 demonstrates the benefit of encapsulation in carbon. The material provided by this invention in which the nanoparticles are encapsulated in a supporting matrix shows much improved capacity retention. The nanocomposite retains 98% of its initial capacity after 50 cycles. By contrast, the capacity of the metallic nanoparticles fades rapidly after five cycles. The electrode containing only Sn also continued to fall rapidly after five cycles, retaining only 13% after 30 cycles.

### Example 2

Example 2 relating to sample 2 provided above in Table 1, and is the synthesis of a Sn metal and Sn-cu alloy carbon composite prepared using the above-described synthesis method. FIG. 6 is an X-ray powder diffraction pattern collected after heat treatment under an inert atmosphere of a precursor mixture containing both Sn and Cu. The pattern identifies the sample as containing two phases. Firstly, Sn and secondly a tin-copper alloy identified as CuSn. These peaks confirm presence of CuSn.

### Exemplary Metal-Ion Cell

Embodiments of the present disclosure relate to a reversible metal-ion cell which incorporates an electrode including the carbon-metal/alloy composite material and which may be repeatedly charged and discharged, to store energy upon charge and produce energy during the discharge.

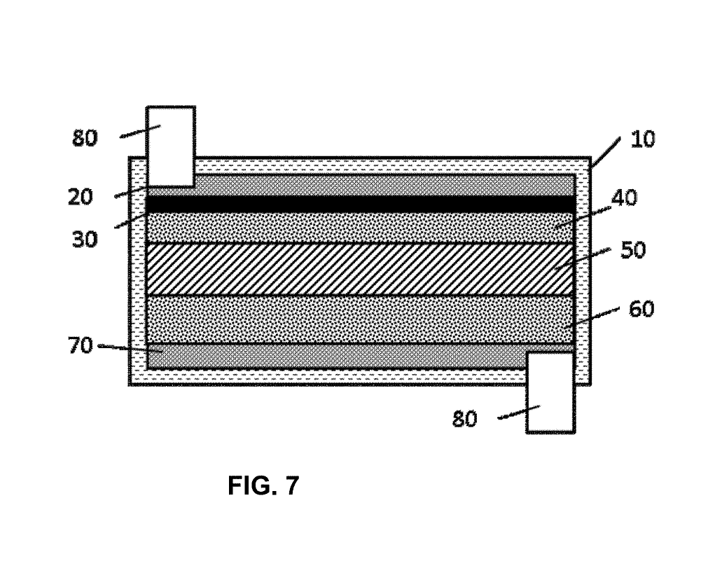

The present disclosure is not particularly limited to a given battery format. The battery format for the present disclosure may include but is not limited to cylindrical cells, button cells, prismatic cells and pouch cells. In FIG. 7, the battery is shown as a pouch cell format. The electrode stack is contained within a laminated pouch material (10) which may prevent short circuit paths, may protect the cell components from reactions with air or moisture, and may contain the cell components within the package. Within the pouch cell (10) there is an electrode stack made of a plurality of anode and cathode layers.

As described in FIG. 7, the cell stack is comprised of an anode (40) including at least a carbon-metal/alloy composite material of the present disclosure. The anode (40) may in addition contain additives for binding the components together and improvement in conduction, increasing conductivity, or other functions. The stack also contains a cathode (60) which incorporates a metal intercalation material, and an ionically conducting electrolyte medium and separator (50), which is sandwiched between the anode (40) and cathode (60). The anode (40) is supported by an anodic current collector (20) and the cathode (60) is supported by a cathodic current collector (70). The anodic current collector (20) may be coated with a protective layer (30). The cell stack is placed inside a container (10), which may be laminated aluminium, which may prevent short circuits and protects the cell from the air. The anode and cathode are connected to an external circuit via tabs (80) which remove and input the electrons into the cell.

The separator (50) may include a thin film which is soaked in a liquid electrolyte. The separator (50) may include a porous film, a non-woven fabric, and a woven fabric, and may be made of a material of a polyolefin resin such as polyethylene and polypropylene, a fluororesin, nylon, and an aromatic aramid can be used, or in some cases cellulosic fibres or material. The thickness of the separator (50) is usually about 10 to 200 μm, and preferably 10 to 30 μm. The separator (50) may be a combination such that separators having differing porosities are laminated. The separator (50) may additionally contain a coating of ceramic, polyvinylidene fluoride (PVFD), a surfactant chemical or any combination thereof. Alternatively, the separator layer (50) may be a ceramic separator. This ceramic separator may for example contain ceramic particles blended with PVDF polymer or may be made by a different method. Alternatively, the separator layer (50) may be a polymer or gel electrolyte, such as polyethylene oxide (PEO), or a block or co polymer such as polyethylene oxide-co-propylene oxide) acrylate. In some embodiments the polymer may be plasticised with a solvent such as propylene carbonate, dimethyl sulfoxide, ethylene glycol, triethylamine, DMF (dimethylformamide), DMSO (dimethyl sulphoxide), polyethoxide ether, poly ethylene succinate, aprotic organic solvents.

The separator layer (50) in some embodiments also contains an electrolyte, the electrolyte material(s) may be any conventional or known material(s) and may comprise either aqueous electrolyte(s) or non-aqueous electrolyte(s) or mixtures thereof. The electrolyte medium may include at least one of an ionic liquid. Examples of solvents usable in the non-aqueous electrolyte of a sodium-ion or lithium-ion secondary battery of the present invention include carbonates such as propylene carbonate (PC), ethylene carbonate (EC), vinylene carbonate, dimethyl carbonate (DMC), diethyl carbonate, ethyl methyl carbonate, isopropyl methyl carbonate, 4-trifluoromethyl-1,3-dioxolan-2-one, and 1,2-di(methoxycarbonyloxy)ethane; ethers such as 1,2-dimethoxyethane, 1,3-dimethoxypropane, pentafluoro propyl methyl ether, 2,2,3,3-tetrafluoropropyl difluoromethyl ether, tetrahydrofuran, and 2-methyltetrahydrofuran; esters such as methyl formate, methyl acetate, and y-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, 1,3-propane sultone, ethylene sulfite, propylene sulfite, dimethyl sulfite, and diethyl sulfite; and those obtained by introducing a fluorine substituent into the above-described organic solvents. Usually, two or more kinds of these solvents are mixed and used. Among these, preferred is a mixed solvent containing carbonates, and more preferred is a mixed solvent of a cyclic carbonate and a non-cyclic carbonate or a mixed solvent of a cyclic carbonate and ethers. These electrolyte solvents advantageously contain an alkali metal conducting salt with a weakly bound cation such as perchlorate ClO4-, PF6-, triflate (CF₃SO₃)—, bis(oxalato) borate (BC₄O₈—, BOB) or imide/TFSI (N(SO₂CF₃)₂).

Ionic liquid electrolytes may be comprised of one or more of the following salts 1-ethyl-3-methylimidazolium bis(trifluoromethylsulfonyl)imide; 1-ethyl-3-methylimidazolium tetrafluoroborate; 1-butyl-3-methylimidazoliumbis(trifluoromethylsulfonyl)imide; 1-butyl-3-methylimidazolium tetrafluoroborate; 1-hexyl-3-methylimidazolium; bis(trifluoromethylsulfonyl)imide; 1-hexyl-3-methylimidazolium tetrafluoroborate; 1-butyl-2,3-dimethylimidazolium bis(trifluoromethylsulfonyl)imide; 1-butyl-2,3-dimethylimidazolium tetrafluoroborate; N-octylpyridinium tetrafluoroborate; N-butyl-4-methylpyridinium tetrafluoroborate; and N-butyl-4-methylpyridinium hexafluorophosphate. Ionic liquids included in electrolyte medium may comprise cations of the pyridine and pyrrollidinium group such as: methyl-1-propyl pyrrolidinium [MPPyrro]+, 1-methyl-1-butyl pyrrolidinium [MBPyrro]+, 1-methyl-1-propyl piperidinium [MPPip]+, 1-methyl-1-butyl piperidinium [MBPip]+, 1-methyl-1-octylpyrrolidinium [MOPyrro]+and 1-methyl-1-octylpiperidinium [MOPip]+.

In some embodiments, the polymer separator film (50) may be replaced with an ionically conducting solid, glass or polymer. Solid electrolytes include garnets, nasicons, lisicons, beta alumina or other alkali metal ion conducting solid oxides or sulphide glasses or solids.

The cathode (60) typically includes a cathode active material, a conductive additive such as carbon black, carbon nanotubes, carbon fibres, tungsten carbide, and a polymeric binder such as PTFE, PVDF, CMC, EPDM, SBR, alginate, polyacrylic acid or PEO or any other appropriate polymeric binder material or mixture thereof.

Active material examples of the cathode (60) include layered oxides such as the lithium, sodium or mixed lithium and sodium transition metal oxides. Examples include P₂-NaxCoO₂, P₂-Na_{2/3}[Nii_{/3}Mn_{2/3}]O₂, Na_{0.4}MnO₂, NaₓMO₂. Sodium transition metal phosphates or sulfates such as NaFePO₄, NaVPO₄F, Na₃V₂(PO4)2F3, Na₂FePO₄F, Na₃V₂(PO₄)₃, Na2M2(SO4)3, Na2M(SO4)2, NaMSO4F and the organic cathode materialP(EO)₈NaCF₃SO₃ (polyethylene oxide sodium trifluoromethanesulfonate) , Where M is in part a redox active transition metal.Lithium cathode materials include, but not exclusively lithium cobaltate, lithium nickel manganese cobalt oxide, lithium iron phosphate, lithium transition metal sulfates and sulfate fluorides (LiFeSO4F, Li2Fe2(SO4)3) and lithium vanadium phosphate fluoride.

The cathode current collector (70) is typically an aluminium foil, or carbon coated aluminium foil for lithium and sodium ion batteries. In some cases, the current collector may be a carbon paper, or graphite foil.

The anode current collector (20) is typically copper foil for lithium cells whereas aluminium can be used as well in sodium ion examples. Other examples of current collector include carbon coated aluminium copper or aluminium foil or stainless steel foils. In some cases, the current collector may be a carbon paper or graphite foil.

### INDUSTRIAL APPLICABILITY

The invention relates to an improvement in metal-ion battery technology and may be applied for use in many different applications such as energy storage devices, rechargeable batteries and electrochemical devices. Advantageously the cells according to the invention increase the capacity of the anode.

1. A carbon-metal/alloy composite material comprising a composition represented by Chemical Formula (1):
(1-a)Sn₁₋ₓM¹ₓ+aM²+cC (1)
wherein:
M¹ includes one or more transition metals, metals, or metalloids;
M² includes one or more transition metals, metals, or metalloids;
x is 0≦x≦1;
a is 0≦a≦1; and
c is 0<c≦99,
wherein the carbonaceous component is a non-macroporous material and the metal/alloy component (1-a)Sn₁₋ₓM¹ₓ+aM² is embodied as particles dispersed in the non-macroporous carbonaceous component (C).

2. The carbon-metal/alloy composite material of claim 1, wherein M¹ is chromium, titanium, vanadium, iron, manganese, cobalt, nickel, copper, zinc, gallium, indium, silicon, germanium, or antimony.

3. The carbon-metal/alloy composite material of claim 1, wherein M² is chromium, titanium, vanadium, iron, manganese, cobalt, nickel, copper, zinc, gallium, indium, silicon, germanium, or antimony.

4. The carbon-metal/alloy composite material of claim 1, wherein M¹ is the same material as M².

5. The carbon-metal/alloy composite material of claim 1, wherein M¹ is a different material than M².

6. The carbon-metal/alloy composite material of claim 1, wherein a is 0.

7. The carbon-metal/alloy composite material of claim 1, wherein a is 1.

8. The carbon-metal/alloy composite material of claim 1, wherein one or both of M¹ and M² comprises more than one material.

9. The carbon-metal/alloy composite material of claim 1, wherein the metal/alloy component particles are spherical particles.

10. The carbon-metal/alloy composite material of claim 1, wherein average size of the metal/alloy component particles is 5 nm to 500 nm.

11. The carbon-metal/alloy composite material of claim 1, wherein the non-macroporous carbonaceous component (C) is embodied as matrix particles having an average size of 1 μm-150 μm.

12. An electrode comprising the carbon-metal/alloy composite material of claim 1.

13. A metal-ion cell comprising:
an anode comprising the carbon-metal/alloy composite material of claim 1;
a cathode; and
a separator comprising an ionically conducting electrolyte medium.

14. A method of forming a carbon-metal/alloy composite material comprising a composition represented by Chemical Formula (1):
(1-a)Sn₁₋ₓM¹ₓ+aM²+cC (1)
wherein:
M¹ includes one or more transition metals, metals, or metalloids;
M² includes one or more transition metals, metals, or metalloids;
x is 0≦x≦1;
a is 0≦a≦1; and
c is 0<c≦99, the method comprising:
dissolving one or more precursor materials in a solvent to form a solution;
adding an organic carbon forming precursor to the solution to form a mixture;
heating the mixture in an autoclave reactor for a prescribed period of time;
separating solids formed from the mixture after the heating;
washing the separated solids with one or more washing solvents; and
heating the washed solids under a non-oxidizing atmosphere to form the carbon-metal/alloy composite material.

15. The method of claim 14, wherein the organic carbon forming precursor comprises ethylene glycol.

16. The method of claim 14, further comprising adding an acid or alkali to form the mixture.

17. The method of claim 16, wherein the acid comprises an organic acid.

18. The method of claim 14, wherein the washing solvent comprises ethylene glycol.

19. The method of claim 14,
wherein the carbonaceous component is a non-macroporous material and the metal/alloy component (1-a)Sn₁₋ₓMₓ+aM is embodied as particles dispersed in the non-macroporous carbonaceous component (C).

20. The method of claim 19, wherein the non-macroporous carbonaceous component (C) is embodied as matrix particles having an average size of 1 μm-150 μm.
